(19) United States
(12) Patent Application Publication
(10) Pub. No.: US 2020/0288904 A1
(43) Pub. Date: Sep. 17, 2020

(54) Product and method for stabilizing lemon juice

(71) Applicants: Flor Mariela Chacon Bejarano, Bogota (CO); Kadir Alejandro Malagana Chacon, Bogota (CO); Rafael Guillermo Malagana Chacon, Bogota (CO)

(72) Inventors: Flor Mariela Chacon Bejarano, Bogota (CO); Kadir Alejandro Malagana Chacon, Bogota (CO); Rafael Guillermo Malagana Chacon, Bogota (CO)

(21) Appl. No.: 16/886,219

(22) Filed: May 28, 2020

Related U.S. Application Data
(63) Continuation of application No. 16/104,886, filed on Aug. 18, 2018.

(51) Int. Cl. A47J 31/44; A23F 3/18; A47J 31/10

(52) U.S. Cl. CPC A47J 31/4403; A47J 31/10; A23F 3/18

(57) ABSTRACT

The invention relates to a method for stabilizing lemon juice, by means of which the lemon, after being disinfected, is cut up in order to extract the lemon juice, but not before the natural oils contained in the lemon rind are separated and the seeds thereof are also separated, the lemon juice subsequently being subjected to a predetermined time and temperature range, then cooled to predetermined temperatures in order to generate a thermal shock, followed by the addition thereto of stabilizers and antioxidants. Finally, the lemon juice is packaged.

### CROSS-REFERENCE TO RELATED APPLICATIONS

This application is a Continuation of pending U.S. patent application Ser. No. 16/104,886 titled “Product and Method for Stabilizing lemon juice”, filed on Jun. 15, 2016 as well as to PCT-IB2014-002877 entitled “Producto y proceso de estabilización del zumo de limón”, filed on Dec. 23, 2014, the description of both of the above are incorporated herein by reference in their entirety.

In addition, as part of PCT-IB2014-002877, Colombian Patent Application 13-299261 was filed on 2014 Aug. 21 and became an issued patent in Colombia under Resolution 28733 on Dec. 23, 2013, for which a Patent Prosecution Highway request has been filed herewith.

### DESCRIPTION OF THE RELATED ART

Citrus originated about 20 million years ago in Southeast Asia. They have since undergone many changes due to both natural natural selection and hybridization as manmade. The dispersion of citrus from their places of origin was mainly due to the great migrations, conquests of Alexander the Great spread of Islam, crusades, discovery of America, etc. Studies in the year 1980 the name Tahiti is because it was introduced in California from the island of Tahiti, in the period 1850-1880; and the Persian lime, for coming for the Mediterranean, from Persia place now known as Iran. It is a hybrid triploid, where one parent is an acid lime and the other a citron. The Tahiti lime is a product of extensive culture, its specific origin is unknown, it is presumed to be a hybrid between Citrus aurantifolia Swingle and other citrus species, it is also identified as the Tahiti lime (Citrus latifolia Tanaka). The origin of its origin is Burma, Malaysia and the islands of Indonesia, where he went to India and from there was brought to the Mediterranean areas. In del875 he appeared in California and from there was brought to Ecuador adapting mainly in subtropical valleys, the start of commercial plantations were given just 10 years ago and has great international demand. [1]

The main feature of Tahiti lime is their lack of seed, oval and also has a dark green color during development and then become yellow or light green in the stage of maturation. It is considered mature or ready to eat when you can squeeze the juice easily. The standard maturation is technically defined as the minimum juice content is 42% by volume and at least 45 mm in diameter of the fruit. The fruit of this measure weighs about 54 grams (1.9 ounces), this state of the plant is obtained within 90 to 120 days after flowering, depending on climatic conditions and orchard management. Fruit shell having a thickness of 2 to 3 mm, the fruit is usually a slurry or nipple end style, vary considerably in size and shape. The tree is of medium size, can grow to five meters high, it has a round crown. Lemon is rich in minerals including potassium, magnesium, calcium and phosphorus stand (also contains sodium, iron and fluoride).

Potassium, for example, is essential for life and beneficial for the treatment of hypertension element. It has some B vitamins (B1, B2, B3, B5, B6, PP). Vitamin B1 (thiamine) prevents and cures beriberi disease whose symptoms are paralysis, edema and heart failure. Also involved in the metabolism of carbohydrates. Vitamin PP (niacin) warns against rough skin, pellagra, a disease that is manifested by inflammation of the skin, poor digestion and mental disorders. This vitamin is necessary to maintain healthy skin, digestive system and nervous system.

It is a fruit that could be defined as medicinal par excellence because it acts as a curative in more than 150 diseases where toxins either in the blood, organs, tissue, lemon are once ingested comes to combat dissolving their accruals and expel them.

In cases of gastrointestinal poisoning from eating bad food or bad food or combine heavy and pains digestion of the liver and gallbladder, lemon acts normalizing altered functions, neutralizing toxins and helping their elimination. It is also a major consumer of microbes and the best protector against infectious diseases.

In cases of fever it helps eliminate oxidizing and excreting toxic that are not properly neutralized and eliminated, except rheumatic fever. Lemon is good in cases of hypertension, arteriosclerosis and cardiovascular disease (activating blood circulation), in diabetes contributes to avoid complications related to arteries.

Prevents the formation of kidney stones and can reach dissolve slowly.

Like any drug consumption is directly linked to the physical condition of each person because, although it is a great ally of health also its consumption should be restricted against particularized situations, you may be suffering from an individual being in such cases the not indicated consumption.

### BRIEF DESCRIPTION OF THE DRAWINGS

FIG. 1 shows a flowchart of the proposed process, according to an exemplary embodiment of the invention.

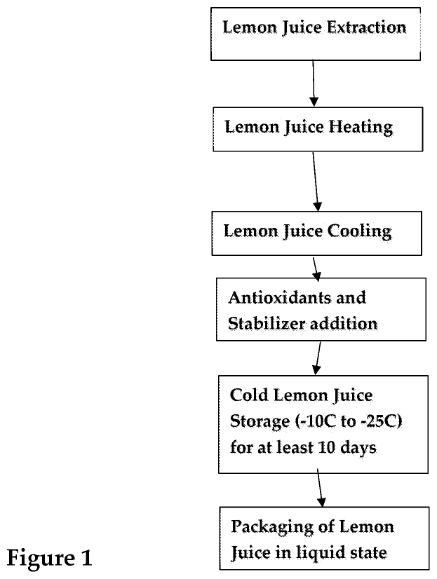

The above-described and other features will be appreciated and understood by those skilled in the art from the following detailed description, drawings, and appended claims.

### DETAILED DESCRIPTION OF THE PREFERRED EMBODIMENT

The preparation and use of various forms of this invention provides many applicable inventive concepts that can be incorporated into a wide plurality of specific contexts such as packaging in sachet, bottle and bag used for commercial, industrial and medicinally.

The stabilization process is performed lemon juice in a food processing plant itself, considering the following phases:

1) removing the lemon is selected overripe fruit, leaves, branches and debris.

2) lemons are washed by immersion in water,

3) lemons are disinfected by immersion in water disinfectant special food for at least 5 minutes.

4) They turn to go through water to remove any residual disinfectant.

5) Cut lemon into 2 parts.

6) cover the squeezer machine is placed to absorb the natural oils of lemon peel.

7) lots of lemon squeezers are placed in the machine to extract the juice of lemon.

8) the seeds of lemon juice are immediately extracted by manual casting.

9} is heated immediately seeded lemon juice (to prevent bitter) at a temperature ranging from a minimum of 60 * C up to 95° C. in a time range between 30 and 60 seconds.

10) The hot lemon juice is cooled down by heat shock at a temperature in a range between 30° C. and O “C 11) antioxidant stabilizers and the lemon juice were added.

12) The stabilized lemon juice is stored in cold temperature of −10° C. to −25 “C for at least 10 days.

13) The lemon juice is stabilized in liquid state is packed in special packaging (plastic laminate, bilayer coextruded polyester, 12-gauge polyethylene) or glass to prevent lemon acidity corrode the packaging container.

### Advantages of the Invention

The product obtained by the stabilization process allows:

Keep frozen for more than two years preserving their organoleptic and physical properties while Keep it up to 12 months at room temperature preventing the breakdown and growth of fungi, yeasts and bacteria that affect their physical and organoleptic characteristics.

Let's be handled, stored and transported smoothly for any climate while maintaining all physical and organoleptic characteristics.

Its composition is of 94.75% natural lemon juice.

This invention has industrial, medical and commercial applications. References: [1] PROJECT FEASIBILITY TAHITI LEMON TO EXPORT TO CANADA 2004-2014 Aguas Francisco, Hector Frire

1. A method for stabilizing lemon juice, said method consisting of:
providing a lemon pressing machine having a 100% natural fiber cloth enclosing said machine's lemon pressing mechanism;
extracting the lemon juice from two or more lemon pieces simultaneously without allowing the natural oil contained within the lemon peel to mix with said juice, wherein said oil is isolated from said juice through the placement of a 100% natural fiber cloth over the lemon pressing portion of said machine;
separation any lemon seeds from said two or more lemons from said lemon juice by keeping said seeds within said 100% natural fiber cloth;
immediate heating of said lemon juice to a minimum temperature of between 60 centigrade and 95 centigrade for between 30 and 60 seconds;
thermal shock cooling of said lemon juice to between 0 centigrade and 30 centigrade; and
storage of said lemon juice at a temperature of between −10 C and 25 C for at least 10 days.

2. the method of claim 1 wherein;
xanthan is added to the cold lemon juice at a ratio of 0.01% to 0.25% by weight of said lemon juice.

3. the method of claim 1 wherein;
ascorbic acid and/or citric acid is added to the cold lemon juice at a ratio of 1% to 2% by weight of said lemon juice according to said cold lemon juice pH and Brix scale.

4. the method of claim 1 wherein;
glucose is added to the cold lemon juice at a ratio of 0.5% to 2.0% by weight of said lemon juice according to said cold lemon juice pH and Brix scale.

5. the method of claim 1 wherein:
sodium benzoate and/or potassium sorbate is added to the cold lemon juice at a ratio of 0.25% to 1.0% by weight of said lemon juice according to said cold lemon juice pH and Brix scale; and
said combined cold lemon juice may be stored frozen for a period over two years.

6. A method for stabilizing lemon juice comprising:
providing a lemon pressing machine having a 100% natural fiber cloth enclosing said machine's lemon pressing mechanism;
extracting the lemon juice from two or more lemon pieces simultaneously without allowing the natural oil contained within the lemon peel to mix with said juice, wherein said oil is isolated from said juice through the placement of a 100% natural fiber cloth over the lemon pressing portion of said machine;
separation any lemon seeds from said two or more lemons from said lemon juice by keeping said seeds within said 100% natural fiber cloth;
immediate heating of said lemon juice to a minimum temperature of between 60 centigrade and 95 centigrade for between 30 and 60 seconds;
thermal shock cooling of said lemon juice to between 0 centigrade and 30 centigrade; and
storage of said lemon juice at a temperature of between −10 C and 25 C for at least 10 days.

7. the method of claim 6 wherein;
xanthan is added to the cold lemon juice at a ratio of 0.01% to 0.25% by weight of said lemon juice.

8. the method of claim 6 wherein;
ascorbic acid and/or citric acid is added to the cold lemon juice at a ratio of 1% to 2% by weight of said lemon juice according to said cold lemon juice pH and Brix scale.

9. the method of claim 6 wherein;
glucose is added to the cold lemon juice at a ratio of 0.5% to 2.0% by weight of said lemon juice according to said cold lemon juice pH and Brix scale.

10. the method of claim 6 wherein:
sodium benzoate and/or potassium sorbate is added to the cold lemon juice at a ratio of 0.25% to 1.0% by weight of said lemon juice according to said cold lemon juice pH and Brix scale; and
said combined cold lemon juice may be stored frozen for a period over two years.
